(19) United States
(12) Patent Application Publication
(10) Pub. No.: US 2026/0339254 A1
(43) Pub. Date: Oct. 29, 2026

(54) IMAGE FORMING APPARATUS

(71) Applicant: SHARP KABUSHIKI KAISHA, Sakai City (JP)

(72) Inventor: Hiroki KINOSHITA, Sakai City (JP)

(21) Appl. No.: 19/657,492

(22) Filed: Apr. 24, 2026

(30) Foreign Application Priority Data
Apr. 24, 2025 (JP) 2025-072081

(51) Int. Cl. G03G 15/00

(52) U.S. Cl. CPC G03G 15/6511; G03G 15/5004; G03G 15/5016; G03G 15/5087; G03G 15/553; G03G 2215/00556; G03G 2215/00725

(57) ABSTRACT

An image forming apparatus includes: a cassette including a sheet stacking tray that stacks a sheet, the cassette being provided in an insertable and removable manner; and a controller that performs a control of positioning the sheet stacking tray at a sheet feeding position when the image forming apparatus is in an energized state and the cassette is inserted into the image forming apparatus, in which the sheet stacking tray moves to a reference position below the sheet feeding position when at least a part of the cassette is removed from the image forming apparatus, and when the sheet stacking tray is not located at the sheet feeding position when the image forming apparatus has transitioned from a non-energized state to the energized state, the controller executes notification processing of providing a notification that there is a possibility that the sheet has been changed.

### INCORPORATION BY REFERENCE

This application is based upon and claims the benefit of priority from JP 2025-72081 A filed on Apr. 24, 2025, the entire contents of which are incorporated herein by reference.

### TECHNICAL FIELD

The disclosure relates to an image forming apparatus.

### BACKGROUND ART

In the prior art, an image forming apparatus is known that includes a remaining-sheet-amount detection means that detects a remaining amount of sheets in the image forming apparatus, and a cassette open/close detection means that detects opening and closing of a cassette in a sleep mode. In the image forming apparatus known in the prior art, the open/close detection means is energized in the sleep mode, and when opening/closing of the cassette is detected by the cassette open/close detection means, the remaining-sheet-amount detection means operates to detect the remaining amount of sheets in the cassette.

### SUMMARY OF INVENTION

When the sheet in the sheet stacking tray of the image forming apparatus is replaced with a sheet not expected by a user, or when a sheet not expected by the user is added, the user cannot recognize that printing has been performed on a sheet not expected by the user until the user confirms the printed sheet.

In the prior art, when the cassette is opened and closed while the open/close detection means is not energized, it is not possible to detect the remaining amount of sheets in the cassette. In view of this, an object is to provide an image forming apparatus that can notify that there is a possibility of change of the sheet when the sheet has been changed while the image forming apparatus is not energized.

An image forming apparatus according to an aspect of the disclosure includes: a cassette including a sheet stacking tray that stacks a sheet, the cassette being provided in an insertable and removable manner; and a controller that performs a control of positioning the sheet stacking tray at a sheet feeding position when the image forming apparatus is in an energized state and the cassette is inserted into the image forming apparatus, in which the sheet stacking tray moves to a reference position below the sheet feeding position when at least a part of the cassette is removed from the image forming apparatus, and when the sheet stacking tray is not located at the sheet feeding position when the image forming apparatus has transitioned from a non-energized state to the energized state, the controller executes notification processing of providing a notification that there is a possibility that the sheet has been changed.

### BRIEF DESCRIPTION OF THE DRAWINGS

FIG. 1 is a diagram illustrating an example of a structure of an image forming apparatus.

FIG. 2 is a diagram for describing details of a sheet supply device.

FIG. 3 is a diagram illustrating an example of a state where a sheet stacking tray is not pushed up.

FIG. 4 is a diagram illustrating an example of a state where the sheet stacking tray is pushed up.

FIG. 5 is a block diagram illustrating an example of a functional configuration of the image forming apparatus.

FIG. 6 is a flowchart illustrating an example of an operation of an image forming apparatus according to a first embodiment.

FIG. 7 is a diagram illustrating an example of a notification screen of a notification message.

FIG. 8 is a flowchart illustrating an example of an operation of an image forming apparatus according to a second embodiment.

### DESCRIPTION OF EMBODIMENTS

### First Embodiment

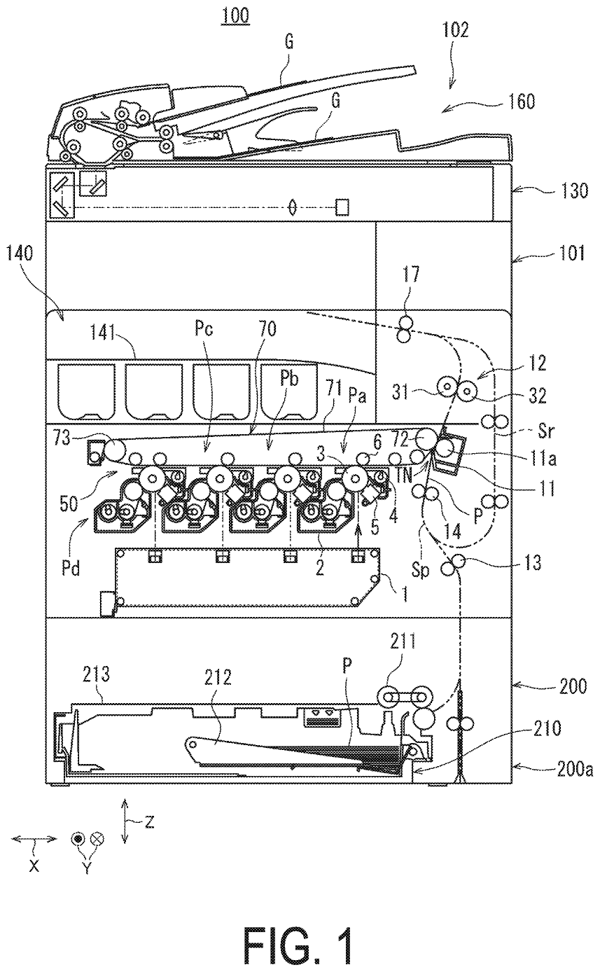

A first embodiment is described below with reference to FIGS. 1 to 7. Note that in the drawings, the same or similar elements are denoted by the same reference signs, and redundant description thereof will be omitted.

FIG. 1 is a diagram illustrating an example of a structure of an image forming apparatus 100. The image forming apparatus 100 has a copy function, a print function, and the like. The image forming apparatus 100 includes an image forming device body 101, an image reading device 130, a document sending device 160, and a sheet supply device 200.

The image forming apparatus 100 forms an image of a document G read by the image reading device 130 or an image received from an external source onto a sheet P in color or monochrome.

The document sending device 160 is provided on the upper side of the image reading device 130 and supported so as to be openable and closable with respect to the image reading device 130. The document sending device 160 sequentially conveys one or more documents G one by one. The image reading device 130 reads one or more documents G conveyed one by one by the document sending device 160.

The image forming device body 101 includes an image transferor 50, an optical scanning device 1, an intermediate transfer belt device 70, a secondary transfer device 11, a fixing device 12, a sheet conveying path Sp, a sheet stacking tray 212, and a discharge tray 141.

The image forming apparatus 100 handles image data corresponding to a color image using each of black, cyan, magenta, and yellow, or to a monochrome image using a single color (for example, black).

The image transferor 50 of the image forming apparatus 100 includes four image stations Pa, Pb, Pc, and Pd corresponding to respective colors of black, cyan, magenta, and yellow. Each of the image stations Pa, Pb, Pc, and Pd includes a development device 2, a photoreceptor drum 3, a drum cleaning device 4 and a charger 5, and the image stations Pa, Pb, Pc, and Pd form four types of toner images. That is, four development devices 2, four photoreceptor drums 3, four drum cleaning devices 4, and four chargers 5 are provided, and are respectively associated with black, cyan, magenta, and yellow.

The optical scanning device 1 exposes the surface of the photoreceptor drum 3 to form an electrostatic latent image.

The development device 2 develops the electrostatic latent image on the surface of the photoreceptor drum 3, and forms a toner image on the surface of the photoreceptor drum 3. The drum cleaning device 4 removes and collects the remaining toner on the surface of the photoreceptor drum 3. The charger 5 uniformly charges the surface of the photoreceptor drum 3 to a predetermined potential. Through the above-described series of operations, toner images of respective colors are formed on the surfaces of the photoreceptor drums 3.

The intermediate transfer belt device 70 includes an intermediate transfer roller 6, an intermediate transfer belt 71, an intermediate transfer driving roller 72, and an intermediate transfer driven roller 73. The intermediate transfer belt 71 is an endless belt capable of circulating movement, and is wound around the intermediate transfer driving roller 72 and the intermediate transfer driven roller 73. Four intermediate transfer rollers 6 are provided inside the intermediate transfer belt 71 so as to form four types of toner images corresponding to the respective colors. The intermediate transfer roller 6 transfers toner images of respective colors formed on the surfaces of the photoreceptor drums 3 onto the intermediate transfer belt 71.

The image forming apparatus 100 sequentially transfers and superimposes toner images of respective colors formed on the surfaces of the photoreceptor drums 3, thereby forming color toner images on the surface of the intermediate transfer belt 71.

The secondary transfer device 11 forms a transfer nip region TN between a secondary transfer roller 11a and the intermediate transfer belt 71, and conveys the sheet P conveyed through the sheet conveying path Sp by nipping it in the transfer nip region TN. When the sheet P passes through the transfer nip region TN, the toner image on the surface of the intermediate transfer belt 71 is transferred to the sheet P, and the sheet P is then conveyed to the fixing device 12.

The fixing device 12 includes a fixing roller 31 and a pressure roller 32. The fixing roller 31 rotates while nipping the sheet P. The fixing device 12 nips, between the fixing roller 31 and the pressure roller 32, the sheet P on which a toner image has been transferred, and heats and presses the sheet to fix the toner image onto the sheet P. Note that a heater serving as a heat source is disposed inside the fixing roller 31.

A cassette 210 includes the sheet stacking tray 212, and is provided on the lower side of the optical scanning device 1 in an insertable and removable manner. In this specification, a state where at least a part of the cassette 210 is removed from the sheet supply device 200 is referred to as a state where the cassette 210 is opened. In addition, a state where the entirety of the cassette 210 is inserted into the sheet supply device 200 is referred to as a state where the cassette 210 is closed.

The sheet P is pulled out from the sheet stacking tray 212 by a sheet feeding roller 211, and conveyed to the sheet conveying path Sp. The sheet P conveyed to the sheet conveying path Sp is conveyed to an ejection roller 17 through the secondary transfer device 11 and the fixing device 12, and discharged to the discharge tray 141 in an ejector 140. In the sheet conveying path Sp, a conveyance roller 13, a registration roller 14, and the ejection roller 17 are disposed. The conveyance roller 13 facilitates conveyance of the sheet P. The registration roller 14 temporarily stops the sheet P to align the leading end of the sheet P. The registration roller 14 conveys the temporarily stopped sheet P in synchronization with the timing of the color toner image on the intermediate transfer belt 71. The color toner image on the intermediate transfer belt 71 is transferred to the sheet P in the transfer nip region TN between the intermediate transfer belt 71 and the secondary transfer roller 11a.

Note that FIG. 1 illustrates one sheet supply device 200, but the number of the sheet supply devices 200 is not limited to one. For example, the image forming apparatus 100 may include a plurality of sheet supply devices 200. Different types of sheets P may be respectively stacked therein.

In addition, when the image forming apparatus 100 forms an image not only on the front surface of the sheet P but also on the rear surface, the image forming apparatus 100 conveys the sheet P from the ejection roller 17 to a sheet reversing path Sr in a reverse direction. The image forming apparatus 100 reverses the front and rear of the sheet P conveyed in the reverse direction, and guides it to the registration roller 14 again. In addition, the image forming apparatus 100 forms an image on the rear surface of the sheet P guided to the registration roller 14 as on the front surface, and conveys the sheet P to the discharge tray 141.

The sheet supply device 200 is configured such that the cassette 210 is insertable into and removable from a sheet supply device body 200a in a front-rear direction X, which is a predetermined insertion/removal direction. The cassette 210 includes the sheet stacking tray 212, a push-up member 231, an elevation driver 230, and an upper limit detector 221.

The sheet stacking tray 212 is provided in a vertically movable manner inside the cassette 210, and stacks the sheets P. More specifically, the sheet stacking tray 212 is provided in the sheet supply device 200 so as to be movable back and forth along an up-down direction Z. The sheet stacking tray 212 is a plate-shaped member extending along both a predetermined depth direction X and left-right direction Y set in advance. The depth direction X is a direction of the front surface side and the back side of the sheet supply device 200, and the left-right direction Y is a direction orthogonal to both the depth direction X and the up-down direction Z.

The sheet stacking tray 212 is insertable into and removable from the image forming apparatus 100. The sheet P is pulled out from the sheet stacking tray 212 by the sheet feeding roller 211, and conveyed to the sheet conveying path Sp. The sheet P conveyed to the sheet conveying path Sp is conveyed to the ejection roller 17 through the secondary transfer device 11 and the fixing device 12, and discharged to the discharge tray 141 in the ejector 140.

The push-up member 231 is disposed in contact with the bottom of the sheet stacking tray 212. The sheet stacking tray 212 is vertically movable by being pushed up by the push-up member 231. The elevation driver 230 drives the push-up member such that the push-up member 231 pushes up the sheet stacking tray 212. The upper limit detector 221 detects the upper limit of the sheet stacking tray 212 by detecting the sheet P. For example, the upper limit detector 221 includes a photosensor.

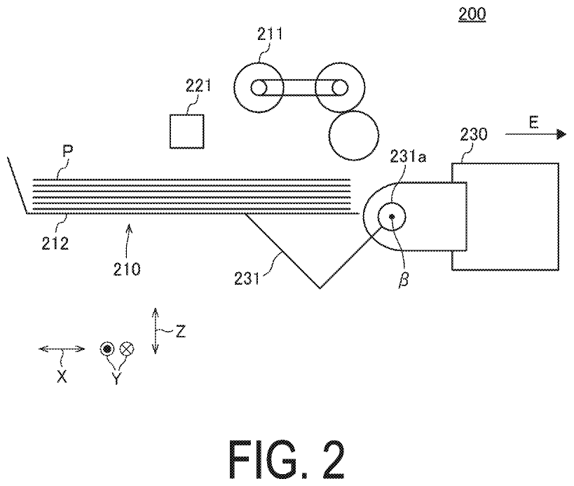

With reference to FIG. 2, the sheet supply device 200 is described below in detail. FIG. 2 is a diagram schematically illustrating an example of a structure of the sheet supply device 200.

The sheet stacking tray 212 is turnably provided about a turning axis line β along the sheet surface orthogonal to a supply direction E of the sheet P with a turning axis 231a as a fulcrum.

The elevation driver 230 is driven to push up the sheet stacking tray 212 through the push-up member 231. The elevation driver 230 includes a motor. In the disclosure, a state where the elevation driver 230 is energized is referred to as a standby state. In the standby state, the elevation driver 230 can operate the push-up member 231 such that the push-up member 231 pushes up the sheet stacking tray 212 and the upper limit detector 221 detects the sheet P.

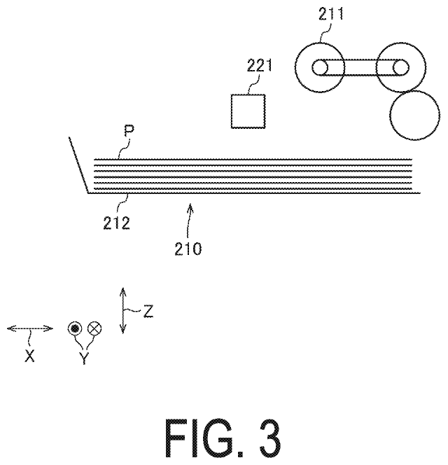

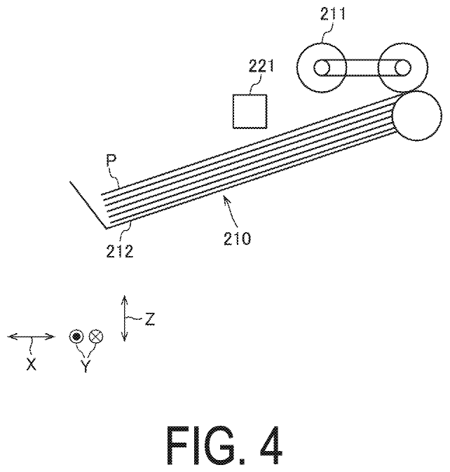

The push-up member 231 is provided at a main body frame 213 of the cassette 210 so as to be turnable about the turning axis line β extending along the up-down direction Z with the turning axis 231a as a fulcrum. In this manner, the push-up member 231 can push up the sheet stacking tray 212 from the lower side by turning about the turning axis line β. That is, the push-up member 231 can push up the sheet stacking tray 212 such that the sheet stacking tray 212 transitions from the state where the sheet stacking tray 212 is not pushed up (see FIG. 3) to the state where the sheet stacking tray 212 is pushed up (see FIG. 4).

When the cassette 210 is mounted to the sheet supply device 200, the cassette 210 and the push-up member 231 make contact with each other. Then, the elevation driver 230 can turn the push-up member 231 about the turning axis line β through rotational driving. As a result, when the elevation driver 230 turns the push-up member 231 about the turning axis line β, the sheet stacking tray 212 is pushed up by the push-up member 231 (see FIG. 4).

On the other hand, when at least a part of the cassette 210 is separated from the sheet supply device body 200a, the push-up member 231 is separated from the sheet stacking tray 212, and the sheet stacking tray 212 descends to a reference position below a sheet feeding position. That is, when at least a part of the cassette 210 is removed from the image forming apparatus 100, the sheet stacking tray 212 moves to the reference position.

FIG. 3 is a diagram schematically illustrating an example of a state where the sheet stacking tray 212 is not pushed up. As exemplified in FIG. 3, when the sheet stacking tray 212 is not pushed up, a height H of a plurality of sheets P stacked in the sheet stacking tray 212 is lower than the height where the upper limit detector 221 is disposed. Therefore, when the sheet stacking tray 212 is not pushed up, the sheets P stacked in the sheet stacking tray 212 are not detected by the upper limit detector 221.

FIG. 4 is a diagram schematically illustrating an example of a state where the sheet stacking tray 212 is pushed up. As exemplified in FIG. 4, when the sheet stacking tray 212 is pushed up, the uppermost surface of a plurality of sheets P stacked in the sheet stacking tray reaches the height where the upper limit detector 221 is disposed. Therefore, when the sheet stacking tray 212 is pushed up, the sheets P stacked in the sheet stacking tray 212 are detected by the upper limit detector 221.

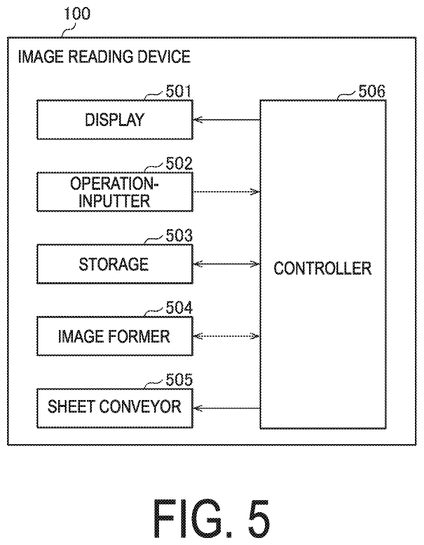

FIG. 5 is a block diagram illustrating an example of a functional configuration of the image forming apparatus 100. The image forming apparatus 100 includes a display 501, an operation-inputter 502, a storage 503, an image former 504, a sheet conveyor 505, and a controller 506.

The display 501 displays information to be presented to the user. For example, the display 501 is composed of a liquid crystal panel, an organic electro-luminescence (EL) panel, or the like. The operation-inputter 502 receives an operation of the user. For example, the operation-inputter 502 is composed of a touch panel or the like. Note that a touch panel display in which the operation-inputter 502 and the display 501 are integrally configured may be provided.

The storage 503 is a recording medium that can record various data, programs, and the like. The storage 503 is composed of one or more hard disk drives (HDD), one or more solid state drives (SSD), one or more semiconductor memories, and the like, for example.

The image former 504 attaches a color material to a sheet to form an image based on document data. The image former 504 is composed of a laser printer using an electrophotographic method, and forms an image on the sheet by attaching toner, which is a color material, to the sheet. The image former 504 is implemented by the image transferor 50, the optical scanning device 1, the intermediate transfer belt device 70, the secondary transfer device 11, and the fixing device 12 exemplified in FIG. 1, and the like.

The sheet conveyor 505 conveys a sheet on which an image has been formed by the image former 504 to a sheet discharge port (not illustrated in the drawing). The sheet conveyor 505 is implemented by the conveyance roller 13, the registration roller 14, and the ejection roller 17 exemplified in FIG. 1, and the like, The controller 506 controls the entirety of the image forming apparatus 100. The controller 506 implements various functions by reading and executing various programs stored in the storage 503. The controller 506 may be implemented by one or more control devices/arithmetic devices (central processing unit (CPU), system on a chip (SoC)), one or more random access memories (RAM), one or more read only memories (ROM), various interface circuits, and the like. In addition, some or all of the processors included in the controller 506 may be composed of an electronic circuit.

When the image forming apparatus 100 is in an energized state and the cassette 210 is inserted into the image forming apparatus 100, the controller 506 performs a control of positioning the sheet stacking tray 212 at the sheet feeding position. That is, when the image forming apparatus 100 is in an energized state and the cassette 210 is in a closed state, the controller 506 performs a control of positioning the sheet stacking tray 212 at the sheet feeding position. In the disclosure, the energized state refers to a state where the power of the image forming apparatus 100 is ON and the elevation driver 230 is energized.

When the upper limit detector 221 detects the sheet P, the controller 506 determines that the sheet stacking tray 212 is located at the sheet feeding position. On the other hand, when the upper limit detector 221 does not detect the sheet P, the controller 506 determines that the sheet stacking tray 212 is not located at the sheet feeding position.

Further, when the image forming apparatus 100 transitions from a non-energized state to an energized state and the sheet stacking tray 212 is not located at the sheet feeding position, the controller 506 executes notification processing of providing a notification that there is a possibility that the sheet P has been changed. In the disclosure, the non-energized state refers to a state where the power of the image forming apparatus 100 is OFF, or the elevation driver 230 is not energized. In the disclosure, a state where the elevation driver 230 is not energized is also referred to as a sleep state.

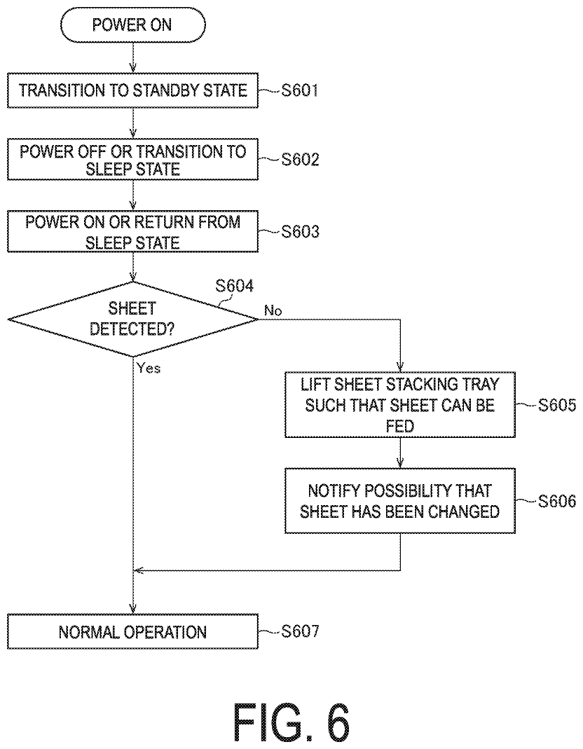

FIG. 6 is a flowchart illustrating an example of an operation of the image forming apparatus 100 according to the present embodiment. It is assumed that when the controller 506 executes the processing of step S601, the power of the image forming apparatus 100 is ON.

At step S601, the controller 506 transitions the image forming apparatus 100 to the standby state. Here, at step S601, the controller 506 causes the elevation driver 230 to operate the push-up member 231 such that the push-up member 231 pushes up the sheet stacking tray 212 and the upper limit detector 221 detects the sheet P.

Further, it is assumed that from the state where the power of the image forming apparatus 100 is ON and the standby state, the power of the image forming apparatus 100 is turned OFF or the state transitions to the sleep state at step S602. That is, it is assumed that the image forming apparatus 100 has transitioned from the energized state to the non-energized state. In that case, in the state where the power of the image forming apparatus 100 is OFF or in the sleep state, the state where the sheet stacking tray 212 is pushed up by the push-up member is maintained such that the upper limit detector 221 detects the sheet P. Further, it is assumed that the elevation driver 230 is not energized in the state where the power of the image forming apparatus 100 is OFF or in the sleep state.

When the cassette 210 is opened in the state where the power of the image forming apparatus 100 is OFF or in the sleep state, the push-up member 231 is separated from the sheet stacking tray 212, and the sheet stacking tray 212 moves to a reference position set in advance. In this manner, the user can replace or add the sheets P to be stacked in the sheet stacking tray 212.

When the cassette 210 is closed, the cassette 210 and the push-up member 231 make contact with each other. However, in the state where the power of the image forming apparatus 100 is OFF or in the sleep state, the elevation driver 230 is not energized, and therefore the elevation driver 230 is not driven. As a result, when the cassette 210 is opened and closed in the state where the power of the image forming apparatus 100 is OFF or in the sleep state, the sheet stacking tray 212 is maintained at the reference position without being moved to the sheet feeding position. That is, when the cassette 210 is opened and closed in the state where the image forming apparatus 100 is in the non-energized state, the sheet stacking tray 212 is maintained at the reference position without being moved to the sheet feeding position.

It is assumed that at step S603, the state returns from the state where the power of the image forming apparatus 100 is OFF or the sleep state into the state where the power of the image forming apparatus 100 is ON, or the state returns from the sleep state. That is, it is assumed that the image forming apparatus 100 has transitioned from the non-energized state to the energized state. For example, when the operation-inputter 502 receives an operation of returning from the sleep state, the controller 506 executes processing of returning from the sleep state. In addition, for example, when the image forming apparatus 100 has received image data transmitted from a terminal device and a printing instruction transmitted from the terminal device through a network, the controller 506 executes processing of returning from the sleep state. When the controller 506 executes processing of returning from the sleep state, the controller 506 transitions the image forming apparatus 100 to the standby state. In this manner, the controller 506 energizes the elevation driver 230.

At step S604, the controller 506 determines whether the upper limit detector 221 has detected the sheet P. When the sheet stacking tray 212 is pushed up by the push-up member 231 to the sheet feeding position and is maintained at the sheet feeding position in the non-energized state, the upper limit detector 221 detects the sheet P at step S604. That is, when the cassette 210 is not opened after the image forming apparatus 100 has transitioned to the non-energized state and before the image forming apparatus 100 transitions to the energized state, the state where the sheet stacking tray 212 is located at the sheet feeding position in the non-energized state is maintained. Therefore, when the cassette 210 is not opened after the image forming apparatus 100 has transitioned from the energized state to the non-energized state and before the image forming apparatus 100 transitions to the energized state, the upper limit detector 221 detects the sheet P at step S604.

On the other hand, when the sheet stacking tray 212 is not pushed up by the push-up member 231 to the sheet feeding position, the upper limit detector 221 does not detect the sheet P at step S604. For example, when the sheet stacking tray 212 has descended to the reference position, the upper limit detector 221 does not detect the sheet P at step S604. That is, when the cassette 210 is opened after the image forming apparatus 100 has transitioned from the energized state to the non-energized state and before the image forming apparatus 100 transitions to the energized state, the upper limit detector 221 does not detect the sheet P at step S604.

When the upper limit detector 221 detects the sheet P at step S604, the controller 506 advances the processing to step S607. On the other hand, when the upper limit detector 221 does not detect the sheet P at step S604, the controller 506 lifts the sheet stacking tray 212 such that the sheet P can be fed at step S605. More specifically, the controller 506 drives the elevation driver 230 and causes the elevation driver 230 to operate the push-up member 231. That is, the elevation driver 230 lifts the sheet stacking tray 212 such that the push-up member 231 pushes up the sheet stacking tray 212 and the sheet P can be fed.

When the cassette 210 is opened in the state where the power of the image forming apparatus 100 is OFF or in the sleep state, the controller 506 executes processing of moving the sheet stacking tray 212 to the sheet feeding position such that the sheet P can be fed after the power of the image forming apparatus 100 is turned ON, or after returning from the sleep state. That is, the controller 506 executes processing of moving the sheet stacking tray 212 to the sheet feeding position such that the sheet P can be fed after the image forming apparatus 100 has transitioned from the non-energized state to the energized state.

Here, when the cassette 210 is opened, there is a possibility that the user adds or replaces the sheet P. Further, when the sheet P is added or replaced, there is a possibility that the sheet P is replaced with a sheet different from the sheet P stacked in the sheet stacking tray 212, or that the different sheet is added.

For example, it is assumed that a second user different from a first user who performs an operation of turning ON the power of the image forming apparatus 100 or an operation of returning from the sleep state adds or replaces the sheet P in the state where the power of the image forming apparatus 100 is OFF, or in the sleep state, In that case, there is a possibility that the sheet P has been replaced with a sheet P not expected by the first user, or that a sheet P not expected by the first user has been added.

For example, it is assumed that the first user performs an operation for double-sided printing with the expectation that double-sided blank sheets are stacked in the stacking tray 212. However, it is assumed that, before the first user performs the operation, the double-sided blank sheets stacked in the stacking tray 212 have been replaced by the second user with sheets having one blank side and one already-printed side in the state where the power of the image forming apparatus 100 is OFF or in the sleep state. In that state, when the image forming apparatus 100 executes double-sided printing, the image former 504 forms an image specified by the double-sided printing on the already-printed side. In that case, the first user may not be able to recognize that printing is not performed on the double-sided blank sheets until the first user confirms the discharged printed sheets.

In view of this, at step S606, the controller 506 executes notification processing of providing a notification that there is a possibility that the sheet P has been changed. A possibility that the sheet P has been changed includes a possibility that the sheet P has been replaced or added. For example, when the first user has performed an operation of turning ON the power of the image forming apparatus 100 and the image forming apparatus 100 has transitioned from the non-energized state to the energized state, the controller 506 executes, as notification processing, processing of displaying on the display 501 a notification message indicating that there is a possibility that the sheet P has been changed.

Alternatively, when image data has been received from a terminal device, and the image forming apparatus 100 has transitioned from the non-energized state to the energized state, the controller 506 executes, as notification processing, processing of providing a notification to the terminal device that there is a possibility that the sheet P has been changed. For example, the controller 506 transmits, to the terminal device, a notification message indicating that there is a possibility that the sheet P has been changed. That is, when image data has been received from a terminal device in the non-energized state, the controller 506 executes, as notification processing, processing of providing a notification to the terminal device that there is a possibility that the sheet P has been changed.

At step S607, the image forming apparatus 100 executes a normal operation. For example, a normal operation refers to an operation in which the operation-inputter 502 receives a user operation, and the controller 506 executes processing of forming images represented by the image data on the sheet P in accordance with the operation received by the operation-inputter 502. In addition, for example, in the case where the image forming apparatus 100 has received image data transmitted from a terminal device and a printing instruction transmitted from the terminal device, a normal operation refers to an operation in which the controller 506 executes processing of forming images represented by the image data on the sheet P based on the printing instruction.

That is, when the upper limit detector 221 does not detect the sheet P after the image forming apparatus 100 has transitioned from the non-energized state to the energized state, the controller 506 provides a notification of a possibility that the sheet P has been changed before the image former 504 executes the processing of forming an image on the sheet P. In this manner, the image forming apparatus 100 can prompt the first user to confirm the sheets P stacked in the sheet stacking tray 212 before the image former 504 executes the processing of forming an image on the sheet P. Thus, the image forming apparatus 100 contributes to avoiding forming an image on a sheet not expected by the first user.

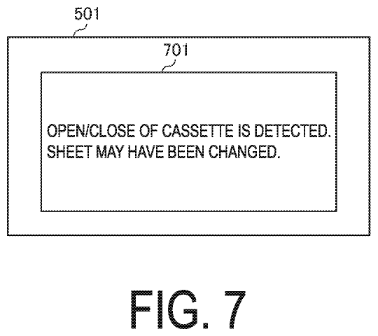

FIG. 7 is a diagram illustrating an example of a notification screen 701 that displays a notification message. More specifically, FIG. 7 illustrates an example of the display 501 including the notification screen 701.

For example, it is assumed that the first user has performed an operation of returning from the sleep state on the operation-inputter 502 when the image forming apparatus 100 is in the sleep state. In that case, when the operation-inputter 502 receives the operation of returning from the sleep state, the controller 506 executes processing of returning from the sleep state. Then, after transitioning to the standby state and before receiving the operation of the first user at the operation-inputter 502, the controller 506 displays the notification screen 701 on the display 501. In this manner, after transitioning from the sleep state to the standby state and before the first user performs an operation on the operation-inputter 502, the image forming apparatus 100 can prompt the first user to confirm the sheets P stacked in the sheet stacking tray 212.

### Variations

In the image forming apparatus 100 according to the present embodiment, the structure of lifting the sheet stacking tray 212 is not limited to the structure exemplified in FIG. 2. For example, as a variation of the present embodiment, the image forming apparatus 100 may include a structure of lifting the sheet stacking tray 212 using a wire for suspending the sheet stacking tray 212. In that case, in the image forming apparatus 100, the sheet stacking tray 212 may descend by its own weight to a reference position set in advance when the cassette 210 is opened so that the sheet P can be supplied, for example.

On the other hand, the controller 506 lifts the sheet stacking tray 212 such that the upper limit detector 221 detects the sheet P by executing processing of winding up the wire suspending the sheet stacking tray 212. It is assumed that the elevation driver lifts the sheet stacking tray 212 such that the upper limit detector 221 detects the sheet P after the image forming apparatus 100 has transitioned from the non-energized state to the energized state. In that case, at step S606 exemplified in FIG. 6, the controller 506 executes notification processing of providing a notification that there is a possibility that the sheet P has been changed. In this manner, the image forming apparatus 100 according to the present variation contributes to avoiding forming an image on a sheet not expected by the first user as with the image forming apparatus 100 according to the first embodiment.

### Second Embodiment

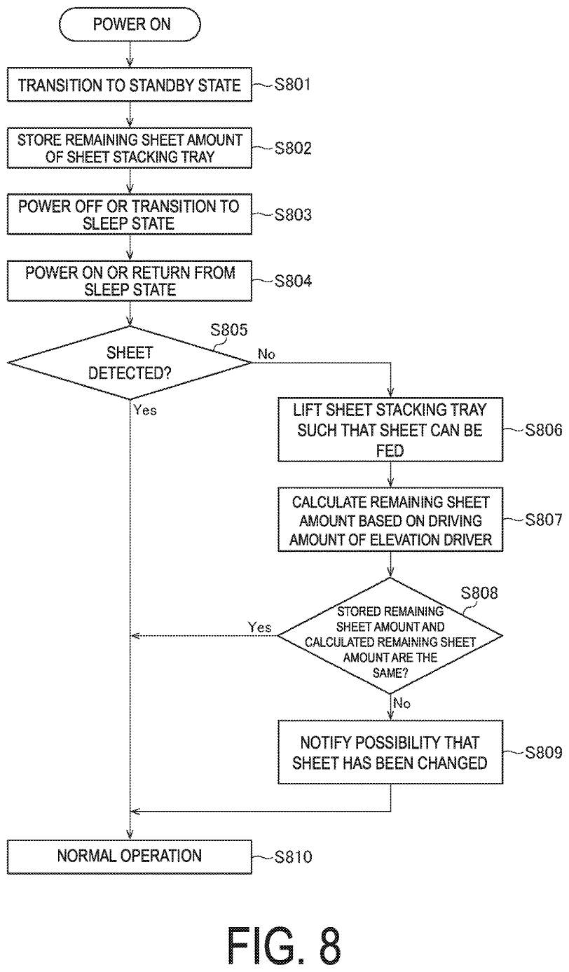

A second embodiment is described below with reference to FIG. 8. Note that in the drawings, the same or similar elements are denoted by the same reference signs, and redundant description thereof will be omitted. Configurations and processing having substantially the same functions as those of other embodiments will be denoted with the same reference signs, and description thereof will be omitted, and differences from the other embodiments will be described.

The controller 506 according to the present embodiment calculates a first remaining sheet amount, and stores the first remaining sheet amount in the storage 503. The first remaining sheet amount represents the remaining amount of the sheets P stacked in the sheet stacking tray 212 in the energized state. For example, when transitioning from the energized state to the non-energized state, the controller 506 calculates the first remaining sheet amount, and stores the first remaining sheet amount in the storage 503.

The controller 506 according to the present embodiment calculates a second remaining sheet amount of the sheets P when the image forming apparatus 100 transitions from the non-energized state to the energized state. The second remaining sheet amount represents the remaining amount of the sheets P stacked in the sheet stacking tray 212 when the image forming apparatus 100 transitions from the non-energized state to the energized state. When the first remaining sheet amount and the second remaining sheet amount are different from each other, the controller 506 executes notification processing of providing a notification that there is a possibility that the sheet P has been changed.

FIG. 8 is a flowchart illustrating an example of an operation of the image forming apparatus 100 according to the present embodiment. It is assumed that when the controller 506 executes the processing of step S801, the power of the image forming apparatus 100 is ON. The processing of step S801 is the same as the processing of step S601 exemplified in FIG. 6, and therefore the description thereof will be omitted.

At step S802, the controller 506 stores the first remaining sheet amount in the storage 503. More specifically, when the sheet stacking tray 212 is moved to the sheet feeding position, the controller 506 calculates the movement amount of the sheet stacking tray 212. For example, when the elevation driver 230 is driven, the controller 506 calculates the driving amount of the elevation driver 230 based on the torque, rotation speed, and the like of the motor constituting the elevation driver 230. Then, the controller 506 calculates the movement amount of the sheet stacking tray 212 based on the driving amount of the elevation driver 230. Alternatively, the controller 506 may calculate the movement amount of the sheet stacking tray 212 based on a movement time required to move the sheet stacking tray 212 to the sheet feeding position. Then, the controller 506 calculates the first remaining sheet amount based on the movement amount of the sheet stacking tray 212.

For example, as the remaining amount of sheets increases, the height H increases. Therefore, as the remaining amount of sheets increases, the height to which the push-up member 231 pushes up the sheet stacking tray 212 for the upper limit detector 221 to detect the sheet P decreases. That is, as the remaining amount of sheets increases, the driving amount of the elevation driver 230 decreases, and the movement amount of the sheet stacking tray 212 decreases. That is, the movement amount of the sheet stacking tray 212 and the remaining sheet amount have a proportional relationship. In view of this, for example, the controller 506 can calculate the remaining sheet amount based on the movement amount of the sheet stacking tray 212.

For example, the storage 503 stores in advance a calculation formula that associates the movement amount of the sheet stacking tray 212 with the remaining sheet amount. In that case, the controller 506 calculates the first remaining sheet amount by inputting the movement amount of the sheet stacking tray 212 into the calculation formula stored in the storage 503. Further, the controller 506 stores, in the storage 503, the first remaining sheet amount calculated when the elevation driver 230 is driven to move the sheet stacking tray 212.

It is assumed that the state transitions from the state where the power of the image forming apparatus 100 is ON and the standby state to the state where the power of the image forming apparatus 100 is OFF or the sleep state at step S803. That is, it is assumed that the image forming apparatus 100 has transitioned from the energized state to the non-energized state. It is assumed that thereafter, from the state where the power of the image forming apparatus 100 is OFF or the sleep state, the power of the image forming apparatus 100 is turned ON, or the state returns from the sleep state at step S804. That is, it is assumed that the image forming apparatus 100 transitions from the non-energized state to the energized state. In that case, the controller 506 determines whether the upper limit detector 221 has detected the sheet P at step S805. The processing from step S803 to step S805 is the same as the processing from step S602 to step S604 exemplified in FIG. 6, and therefore the description thereof will be omitted.

When the upper limit detector 221 detects the sheet P at step S805, the controller 506 advances the processing to step S810. On the other hand, when the upper limit detector 221 does not detect the sheet P at step S805, the controller 506 lifts the sheet stacking tray 212 such that the sheet P can be fed at step S806. The processing of step S806 is the same as the processing of step S605 exemplified in FIG. 6, and therefore the description thereof will be omitted.

At step S807, the controller 506 calculates the second remaining sheet amount based on the movement amount of the sheet stacking tray 212 at step S806. That is, when the image forming apparatus 100 transitions from the non-energized state to the energized state by executing the processing of step S806 and step S807, and the sheet stacking tray 212 has been moved, the controller 506 calculates the second remaining sheet amount based on the movement amount of the sheet stacking tray 212. Note that the processing of calculating the second remaining sheet amount at step S807 is the same as the processing of calculating the first remaining sheet amount at step S802, and therefore the description thereof will be omitted.

At step S808, the controller 506 determines whether the first remaining sheet amount stored in the storage 503 and the second remaining sheet amount calculated at step S807 are the same.

For example, it is assumed that the cassette 210 has been opened and the sheets P to be stacked in the sheet stacking tray 212 have been added after the state has transitioned to the state where the power of the image forming apparatus 100 is OFF or the sleep state at step S803, and before the power of the image forming apparatus 100 is turned ON or returns from the sleep state at step S804. That is, it is assumed that the cassette 210 has been opened and the sheets P to be stacked in the sheet stacking tray 212 have been added after the image forming apparatus 100 has transitioned to the non-energized state, and before the state transitions to the energized state. In that case, a height H1 when the image forming apparatus 100 has transitioned from the non-energized state to the energized state and a height H2 before the image forming apparatus 100 transitions to the non-energized state are different from each other. Therefore, the first remaining sheet amount and the second remaining sheet amount are different from each other.

In addition, for example, it is assumed that after the image forming apparatus 100 has transitioned to the non-energized state and before the image forming apparatus 100 transitions to the energized state, the cassette 210 is opened and the sheets P stacked in the sheet stacking tray 212 are replaced from plain sheets to thick sheets. In that case, since the height H1 and the height H2 are different from each other, the first remaining sheet amount and the second remaining sheet amount are different from each other. Accordingly, in the case where the first remaining sheet amount and the second remaining sheet amount are different from each other, there is a possibility that the sheet P has been changed by opening the cassette 210 after the image forming apparatus 100 has transitioned to the non-energized state and before the image forming apparatus 100 transitions to the energized state.

On the other hand, it is assumed that the cassette 210 has been opened and closed without changing the sheets P stacked in the sheet stacking tray 212 after the image forming apparatus 100 has transitioned to the non-energized state and before the image forming apparatus 100 transitions to the energized state. In that case, the height H1 and the height H2 are the same. Therefore, the first remaining sheet amount and the second remaining sheet amount are the same. Accordingly, when the first remaining sheet amount and the second remaining sheet amount are the same, the sheet P has not been added or replaced.

Accordingly, when it is determined at step S808 that the first remaining sheet amount and the second remaining sheet amount are the same, the controller 506 advances the processing to step S810. When it is determined at step S808 that the first remaining sheet amount and the second remaining sheet amount are not the same, the controller 506 executes notification processing of providing a notification that there is a possibility that the sheet P has been changed at step S809. Then, the controller 506 advances the processing to step S810. The processing is advanced to step S809 and step S810.

When it is determined based on the remaining sheet amount that the sheet P has been changed in the state where the power of the image forming apparatus 100 is OFF or in the sleep state, the image forming apparatus 100 according to the present embodiment executes notification processing of providing a notification that there is a possibility that the sheet P has been changed. On the other hand, when it is determined based on the remaining sheet amount that the sheet P has not been changed in the state where the power of the image forming apparatus 100 is OFF or in the sleep state, the image forming apparatus 100 according to the present embodiment does not execute the notification processing. In this manner, when the cassette 210 has been opened and the sheets P have been replaced or added in the state where the power of the image forming apparatus 100 is OFF or in the sleep state, the image forming apparatus 100 according to the present embodiment prompts the user to confirm the sheets P stacked in the sheet stacking tray 212.

Thus, the image forming apparatus 100 according to the present embodiment can contribute to avoiding forming an image on a sheet not expected by the first user, and can prevent the user from performing unnecessary confirmation.

Each processing executed in the above embodiments is not limited to the processing modes exemplified in each embodiment. The functional blocks described above may be implemented using either a logic circuit (hardware) formed in an integrated circuit or the like, or software using a CPU. Each processing executed in the above embodiments may be executed by a plurality of computers.

The disclosure is not limited to the above embodiments, and may employ a configuration that is substantially the same as the configuration described in the above embodiments, a configuration that achieves the same effects, or a configuration that can achieve the same object. The technical scope of the disclosure also includes embodiments obtained by appropriately combining technical means disclosed in different embodiments. In addition, new technical features can be achieved by combining the technical means disclosed in the respective embodiments.

1. An image forming apparatus comprising:
a cassette including a sheet stacking tray that stacks a sheet, the cassette being provided in an insertable and removable manner; and
a controller that performs a control of positioning the sheet stacking tray at a sheet feeding position when the image forming apparatus is in an energized state and the cassette is inserted into the image forming apparatus, wherein
the sheet stacking tray moves to a reference position below the sheet feeding position when at least a part of the cassette is removed from the image forming apparatus, and
when the sheet stacking tray is not located at the sheet feeding position when the image forming apparatus has transitioned from a non-energized state to the energized state, the controller executes notification processing of providing a notification that there is a possibility that the sheet has been changed.

2. The image forming apparatus according to claim 1, further comprising:
an upper limit detector that detects an upper limit of the sheet stacking tray by detecting the sheet, wherein
the controller determines that the sheet stacking tray is located at the sheet feeding position when the upper limit detector detects the sheet, and
the controller determines that the sheet stacking tray is not located at the sheet feeding position when the upper limit detector does not detect the sheet.

3. The image forming apparatus according to claim 1, further comprising:
a storage that stores a first remaining sheet amount of the sheet, wherein
the controller calculates a second remaining sheet amount of the sheet when the image forming apparatus has transitioned from the non-energized state to the energized state, and
the controller executes the notification processing when the first remaining sheet amount and the second remaining sheet amount are different from each other.

4. The image forming apparatus according to claim 3,
wherein the controller stores the first remaining sheet amount in the storage when transitioning from the energized state to the non-energized state.

5. The image forming apparatus according to claim 3,
wherein when the sheet stacking tray is positioned at the sheet feeding position when the image forming apparatus has transitioned from the non-energized state to the energized state, the controller calculates the second remaining sheet amount based on a movement amount of the sheet stacking tray,

6. The image forming apparatus according to claim 1, further comprising:
a display,
wherein the notification processing includes displaying, on the display, a message indicating that there is the possibility.

7. The image forming apparatus according to claim 1, wherein
when image data has been received from a terminal device in the non-energized state, the controller transitions the state to the energized state, and
the notification processing includes notifying the terminal device of the possibility.
